(19) United States
(12) Patent Application Publication
(10) Pub. No.: US 2021/0160385 A1
(43) Pub. Date: May 27, 2021

(54) INFORMATION PROCESSING APPARATUS, METHOD, AND RECORDING MEDIUM

(71) Applicant: Hiroyuki INOUE, Kanagawa (JP)

(72) Inventor: Hiroyuki INOUE, Kanagawa (JP)

(73) Assignee: Ricoh Company, Ltd., Tokyo (JP)

(21) Appl. No.: 17/104,487

(22) Filed: Nov. 25, 2020

(30) Foreign Application Priority Data
Nov. 26, 2019 (JP) 2019-213645

(51) Int. Cl. H04N 1/00

(52) U.S. Cl. CPC H04N 1/00464; H04N 1/00424; H04N 1/00938; H04N 1/00217

(57) ABSTRACT

An information processing apparatus includes processing circuitry; and a memory storing computer-executable instructions that cause the processing circuitry to call a native application operating on an operating system, in response to a request from a web application that can be used from a web browser.

### CROSS-REFERENCE TO RELATED APPLICATION

The present application is based on and claims priority under 35 U.S.C. § 119 to Japanese Patent Application No. 2019-213645, filed on Nov. 26, 2019, the contents of which are incorporated herein by reference in their entirety.

### BACKGROUND OF THE INVENTION

### 1. Field of the Invention

The present invention relates to an information processing apparatus, method, and recording medium.

### 2. Description of the Related Art

Patent Document 1 discloses an image forming apparatus including a plurality of web page generating means for executing processes according to a request of Hypertext Transfer Protocol (HTTP) and generating a web page for displaying information indicating the process result, and a menu page generating means for generating a web page including menu items for using the plurality of web page means.

Patent Document 1: Japanese Unexamined Patent Application Publication No. 2009-290729

### SUMMARY OF THE INVENTION

According to one aspect of the present invention, there is provided an information processing apparatus including processing circuitry; and a memory storing computer-executable instructions that cause the processing circuitry to call a native application operating on an operating system, in response to a request from a web application that can be used from a web browser.

### BRIEF DESCRIPTION OF THE DRAWINGS

FIG. 1 is a hardware configuration diagram of a multifunction peripheral (MFP) according to an embodiment of the present invention;

FIG. 2 is a diagram illustrating a configuration of software and functions of the MFP according to an embodiment of the present invention;

FIG. 3 is a sequence diagram illustrating an example of a process sequence by the MFP according to an embodiment of the present invention;

FIG. 4 is a sequence diagram illustrating another example of a process sequence by the MFP according to an embodiment of the present invention;

FIG. 5 is a diagram illustrating an example of a home screen displayed on the MFP according to an embodiment of the present invention;

FIG. 6 is a diagram illustrating an example of a display screen of a web application displayed on the MFP according to an embodiment of the present invention;

FIG. 7 is a diagram illustrating an example of a display screen of a scan application displayed on the MFP according to an embodiment of the present invention;

FIG. 8 is a diagram illustrating an example of a display screen of a list of native applications displayed on the MFP according to an embodiment of the present invention; and

FIG. 9 is a diagram illustrating an example of a display screen of an address book application displayed on the MFP according to an embodiment of the present invention.

### DETAILED DESCRIPTION OF THE PREFERRED EMBODIMENTS

In the conventional technology, it is not possible to use a native application from a web application.

A problem to be addressed by an embodiment of the present invention is to enable the usage of a native application from a web application.

Hereinafter, an embodiment of the present invention will be described with reference to the drawings. In the present embodiment, an “application” may be abbreviated as an “app”.

### <Hardware Configuration of a Multifunction Peripheral (MFP) 100>

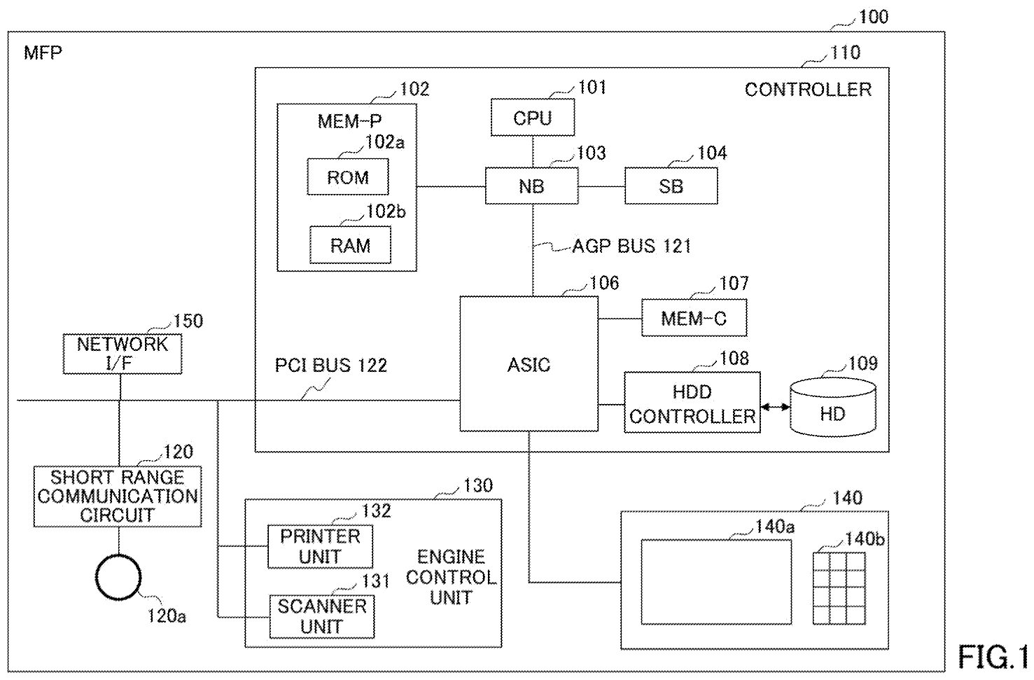

FIG. 1 is a hardware configuration diagram of the MFP 100 according to an embodiment of the present invention. The MFP 100 illustrated in FIG. 1 is an example of an “information processing apparatus”. The MFP 100 is an apparatus having a scanner function, a printer function, a fax function, and the like. As illustrated in FIG. 1, the MFP (Multifunction Peripheral/Product/Printer) 100 includes a controller 110, a short range communication circuit 120, an engine control unit 130, an operation panel 140, and a network interface (I/F) 150.

Among these, the controller 110 includes a central processing unit (CPU) 101 that is the main unit of a computer, a system memory (MEM-P) 102, a north bridge (NB) 103, a south bridge (SB) 104, an Application Specific Integrated Circuit (ASIC) 106, a local memory (MEM-C) 107 as a storage unit, a hard disk drive (HDD) controller 108, and a hard disk (HD) 109 as a storage unit, and is configured such that the NB 103 and the ASIC 106 are connected to each other by an Accelerated Graphics Port (AGP) bus 121.

Among these, the CPU 101 is a control unit that performs overall control of the MFP 100. The NB 103 is a bridge for connecting the CPU 101 to the MEM-P 102, the SB 104, and the AGP bus 121 and has a memory controller for controlling reading and writing to the MEM-P 102, a Peripheral Component Interconnect (PCI) master, and an AGP target.

The MEM-P 102 includes a read-only memory (ROM) 102a, which is a memory for storing programs and data by which each function of the controller 110 is implemented, and a random access memory (RAM) 102b, which is used as a program or data expansion and a rendering memory for memory printing. The program stored in the RAM 102b may be provided by being recorded in a computer-readable recording medium such as a compact disk read-only memory (CD-ROM), a CD recordable (CD-R), or a digital versatile disc (DVD) in a file in an installable format or an executable format.

The SB 104 is a bridge for connecting the NB 103 to PCI devices and peripheral devices. The ASIC 106 is an integrated circuit (IC) for image processing purposes having hardware elements for image processing, and serves as a bridge connecting the AGP bus 121, a PCI bus 122, the HDD controller 108, and the MEM-C 107, respectively. The ASIC 106 includes a PCI target and AGP master, an arbitrator (ARB) that forms the core of the ASIC 106, a memory controller that controls the MEM-C 107, a plurality of Direct Memory Access Controllers (DMACs) that rotate image data by hardware logic, and the like, and a PCI unit that performs data transfer between a scanner unit 131 and a printer unit 132 via the PCI bus 122. The interface of the Universal Serial Bus (USB) or an Institute of Electronic and Electronic Engineers 1394 (IEEE 1394) may be connected to the ASIC 106.

The MEM-C 107 is a local memory used as an image buffer and a code buffer for copying. The HD 109 is a storage device for storing image data, storing font data used for printing, and storing forms. The HD 109 controls the reading or writing of data to the HD 109 according to the control of the CPU 101. The AGP bus 121 is a proposed bus interface for graphics accelerator cards to speed up graphics processing, and by directly accessing the MEM-P 102 with high throughput, the graphics accelerator card can be made faster.

The short range communication circuit 120 is provided with an antenna 120a. The short range communication circuit 120 is a communication circuit such as Near Field Communication (NFC), Bluetooth (registered trademark), and the like.

The engine control unit 130 further includes the scanner unit 131 and the printer unit 132. The operation panel 140 includes a panel display unit 140a, such as a touch panel, which displays a current setting value or a selection screen and accepts input from an operator, and an operation panel 140b, such as a numerical pad which accepts a set value of an image forming condition, such as a density setting condition, and a start key to accept a copy start instruction. The controller 110 controls the entire MFP 100 and controls, for example, rendering, communication, input from the operation panel 140, and the like. The scanner unit 131 or the printer unit 132 includes an image processing portion such as error diffusion or gamma conversion.

In the MFP 100, the application switching key of the operation panel 140 allows sequential switching of the document box function; the copy function, the printer function, and the facsimile function, so that one of these functions can be selected. When the document box function is selected, the document box mode is set, when the copy function is selected, the copy mode is set, when the printer function is selected, the printer mode is set, and when the facsimile function is selected, the facsimile mode is set.

The network I/F 150 is an interface for performing data communication using a communication network. The short range communication circuit 120 and the network I/F 150 are electrically connected to the ASIC 106 via the PCI bus 122.

### <Configuration of Software and Functions of the MFP 100>

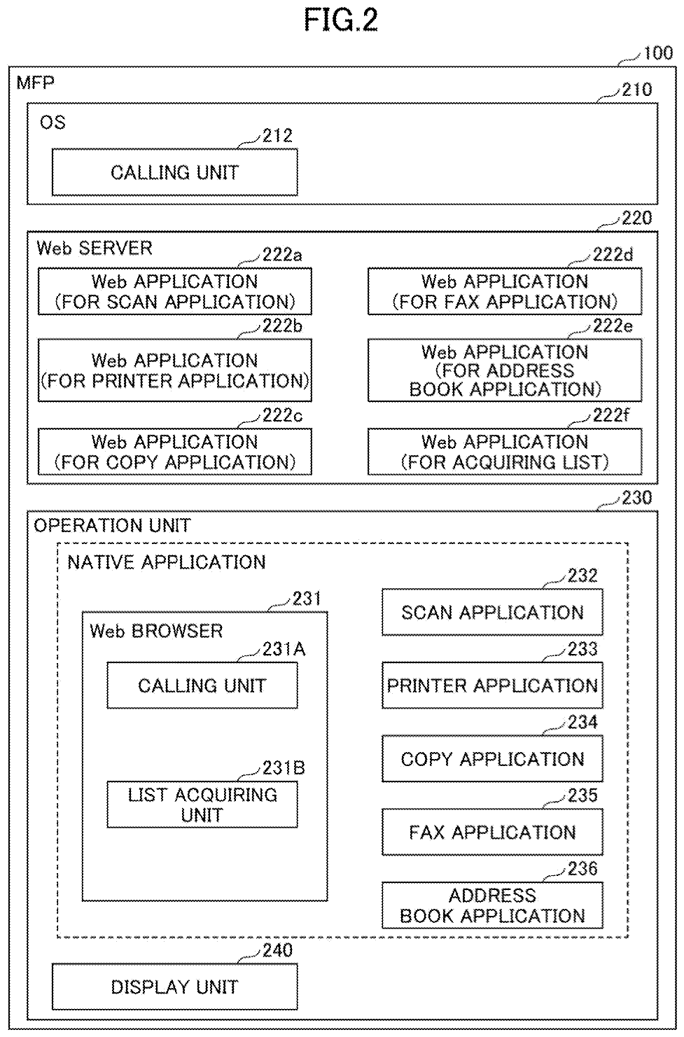

FIG. 2 is a diagram illustrating the configuration of software and functions of the MFP 100 according to an embodiment of the present invention. As illustrated in FIG. 2, the MFP 100 includes an operating system (OS) 210, a web server 220, an operation unit 230, and a display unit 240.

The OS 210 is the basic software of the MFP 100. Each piece of software included in the MFP 100 operates on the OS 210. As the OS 210, for example, Android (registered trademark) and the like is used. The OS 210 includes a calling unit 212. The calling unit 212 calls a specified native application from a web browser 231 (a calling unit 231A), upon being activated from the web browser 231 (the calling unit 231A).

The web server 220 is the operating base of various web applications 222 (222a to 222f). The web server 220 operates the web application 222 specified by a Uniform Resource Locator (URL) included in a request, in response to the request (HyperText Transport Protocol (HTTP) request) from the web browser 231 (i.e., the web client). The web server 220 includes a plurality of the web applications 222. Each of the web applications 222 is activated from the web browser 231 and operates on the web server 220 to implement a predetermined function.

In the present embodiment, the web server 220 includes a plurality of the web applications 222a to 222e with respect to each native application to be called (the calling target).

The web application 222a is the web application 222 for calling a scan application 232 via the web browser 231 (the calling unit 231A).

The web application 222b is the web application 222 for calling a printer application 233 via the web browser 231 (the calling unit 231A).

The web application 222c is the web application 222 for calling a copy application 234 via the web browser 231 (the calling unit 231A).

The web application 222d is the web application 222 for calling a fax application 235 via the web browser 231 (the calling unit 231A).

The web application 222e is the web application 222 for calling an address book application 236 via the web browser 231 (the calling unit 231A).

Further, according to the present embodiment, the web server 220 includes the web application 222f for acquiring a list of native applications and for calling a native application selected by a user from the list of native applications.

The operation unit 230 includes a plurality of native applications. A native application operates directly on the OS 210 and is an application for implementing a predetermined function. In the example illustrated in FIG. 2, the operation unit 230 includes the web browser 231, the scan application 232, the printer application 233, the copy application 234, the fax application 235, and the address book application 236 as examples of native applications.

The web browser 231 can activate the web application 222 stored in the web server 220 or display a display screen (web page) of the web application 222 based on an input URL. The web browser 231 includes the calling unit 231A and a list acquiring unit 231B. The calling unit 231A calls a native application in response to a request from the web application 222. The list acquiring unit 231B acquires a list of native applications in response to a request from the web application 222.

The scan application 232 provides the user with a User Interface (UI) of the scan function included in the MFP 100. The printer application 233 provides the user with the UI of the printer function included in the MFP 100. The copy application 234 provides the user with the UI of the copy function included in the MFP 100. The fax application 235 provides the user with the UI of the fax function included in the MFP 100. The address book application 236 provides the user with the UI of the address book function included in the MFP 100.

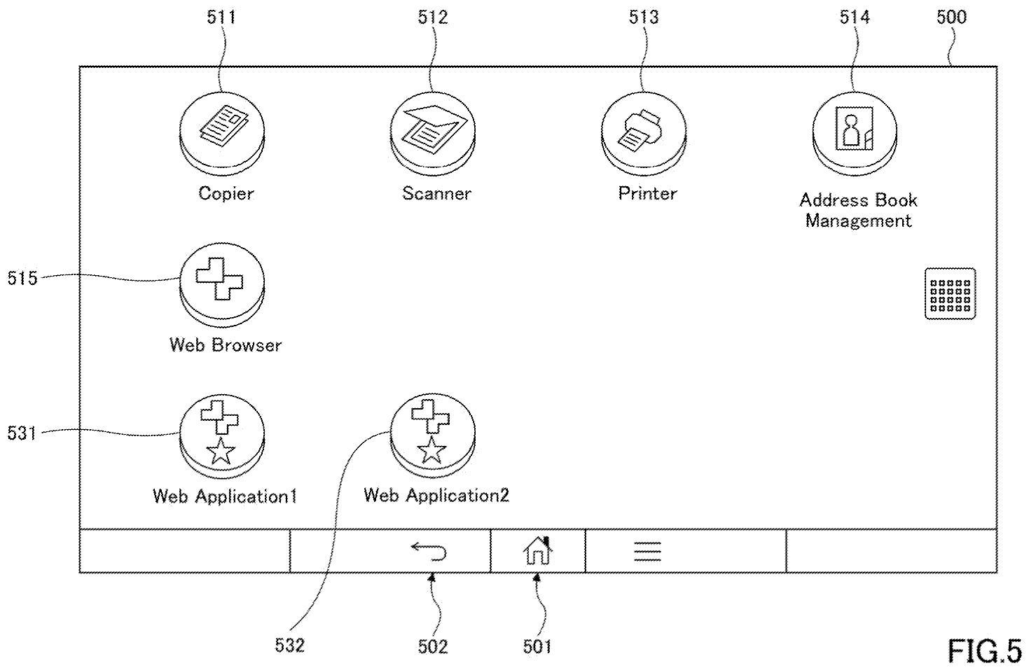

The display unit 240 displays various display screens. For example, the display unit 240 may display a home screen 500 (see FIG. 5), a display screen of the web application 222, a display screen of the native application, and the like.

Each of the pieces of software and functions of the MFP 100 described above is implemented, for example, by executing a program stored in the ROM 102a by the CPU 101 illustrated in FIG. 1.

Each of the functions of the MFP 100 described above may be implemented by one or more processing circuits. As used herein, a “processing circuit” includes a processor programmed to execute each function by software, such as a processor implemented in an electronic circuit, and devices such as an Application Specific Integrated Circuit (ASIC), a digital signal processor (DSP), a field programmable gate array (FPGA), a conventional circuit module, and the like, designed to execute each function as described above.

### <Example of a Process Sequence by the MFP 100>

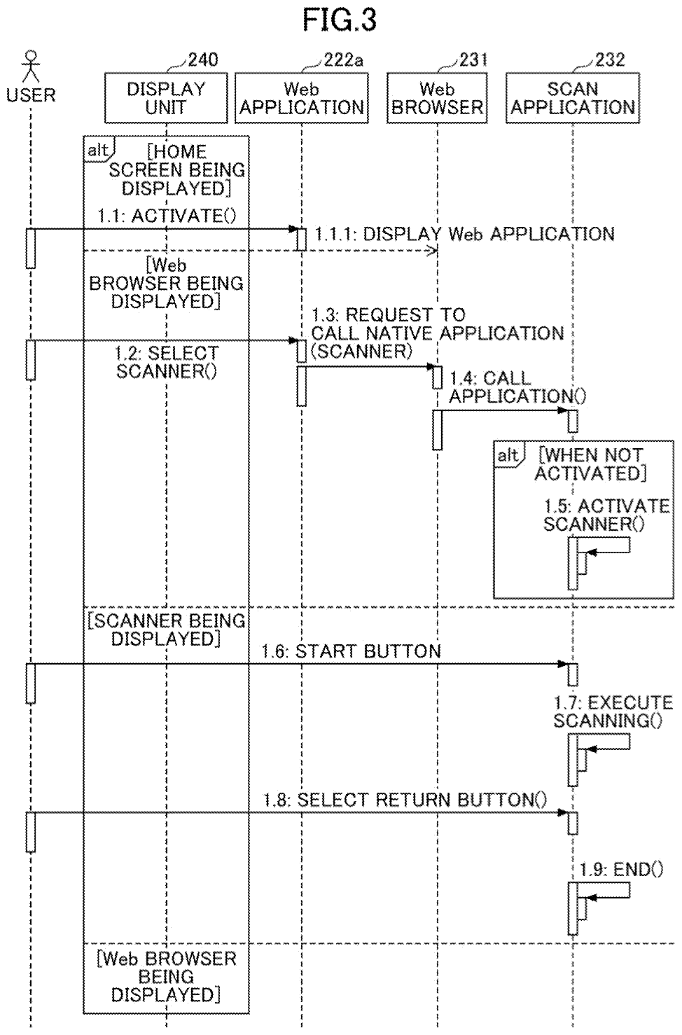

FIG. 3 is a sequence diagram illustrating an example of a process sequence by the MFP 100 according to an embodiment of the present invention. Here, an example in which the scan application 232 is called from the web application 222a will be described.

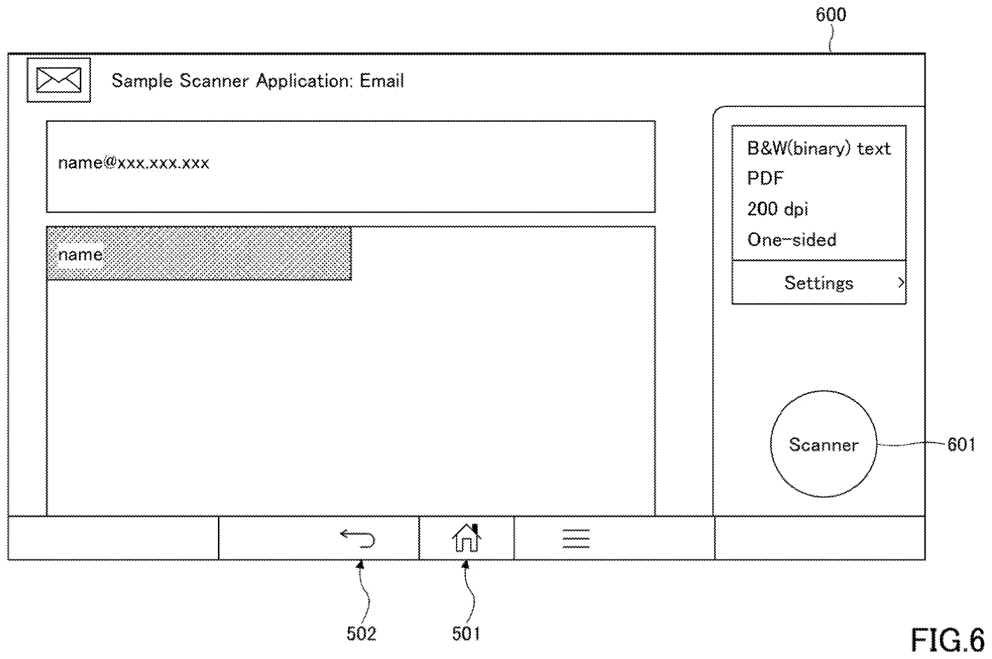

First, when the user selects an icon 531 for activating the web application 222a in the home screen 500 (see FIG. 5) displayed on the display unit 240, the web browser 231 is activated, and the web browser 231 activates the web application 222a from the URL associated with the icon 531 (1.1). When the web application 222a is activated, the web browser 231 displays a display screen 600 (see FIG. 6) of the web application 222a on the display unit 240 (1.1.1).

Next, in the display screen 600 of the web application 222a displayed on the display unit 240, the user selects a scanner button 601 (see FIG. 6) after making the minimum necessary settings (1.2).

In response to the selection of the scanner button 601, the web application 222a requests the web browser 231 to call the scan application 232 (1.3). Specifically, the web application 222a activates the calling unit 231A included in the web browser 231. For example, the calling unit 231A is implemented by an Application Programming Interface (API) using JavaScript (registered trademark). For example, the calling unit 231A includes an API for calling a native application and an API for acquiring the calling result of calling the native application. The API that calls the native application is executed by using a package name of the native application to be called (in this example, the scan application 232) as the parameter. The API, that acquires the calling result of calling the native application, returns “successful” or “unsuccessful” as a parameter of the calling result of calling the native application.

The web browser 231 (the calling unit 231A) calls the scan application 232 in response to a request from the web application 222a (1.4). Specifically, the web browser 231 (the calling unit 231A) calls the scan application 232 by activating the calling unit 212 provided from the OS 210. For example, when the OS 210 is Android, the calling unit 212 is implemented by the startActivity method provided from the OS 210. The calling unit 212 is executed by setting the package name of the native application to be called (in this example, the scan application 232), the activity name, and the parameter to be transferred to the native application to be called.

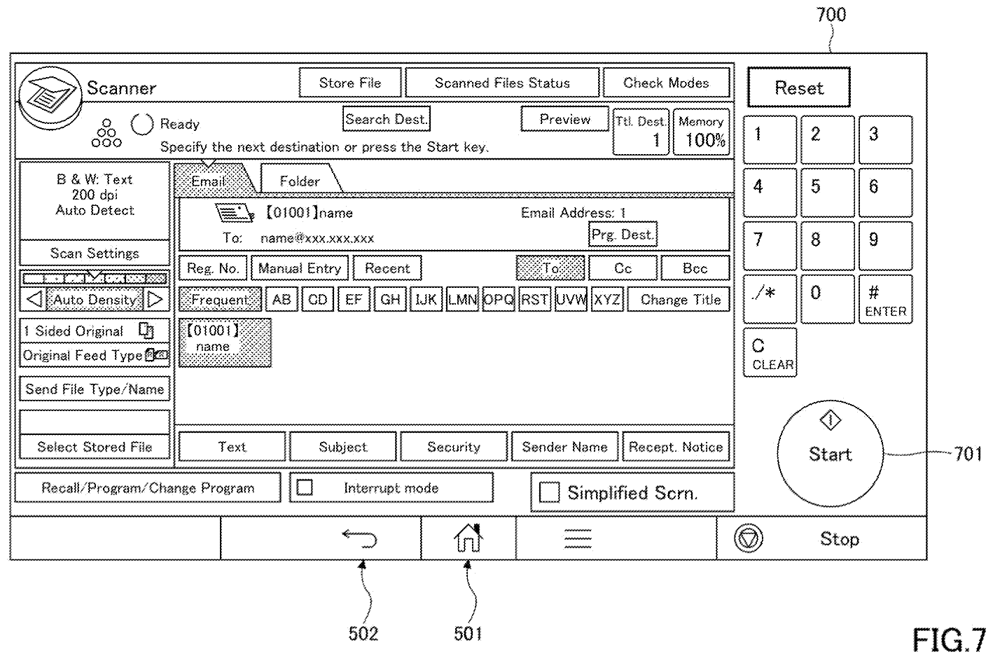

When the scan application 232 has not been activated in response to the call from the web browser 231 (the calling unit 231A), the scan application 232 is activated (1.5), and the display unit 240 displays a display screen 700 (see FIG. 7) of the scan application 232 on the frontmost side of the display. That is, the display unit 240 displays the display screen 700 by superimposing the display screen 700 of the scan application 232 on the display screen 600 of the web application 222a. At this time, the parameter transferred from the calling unit 212 is set in the display screen 700.

When the user selects a start button 701 (see FIG. 7) in the display screen 700 of the scan application 232 displayed on the display unit 240 (1.6), the scan application 232 causes the scanner unit 131 to execute a scanning process (1.7).

When the user selects a return button 502 (see FIG. 7) in the display screen 700 of the scan application 232 displayed in the display unit 240 (1.8), the scan application 232 is terminated (1.9). Accordingly, the display unit 240 ends the display of the display screen 700 of the scan application 232. As a result, the display unit 240 displays the display screen 600 of the web application 222a on the frontmost side of the display.

### <Another Example of a Process Sequence by the MFP 100>

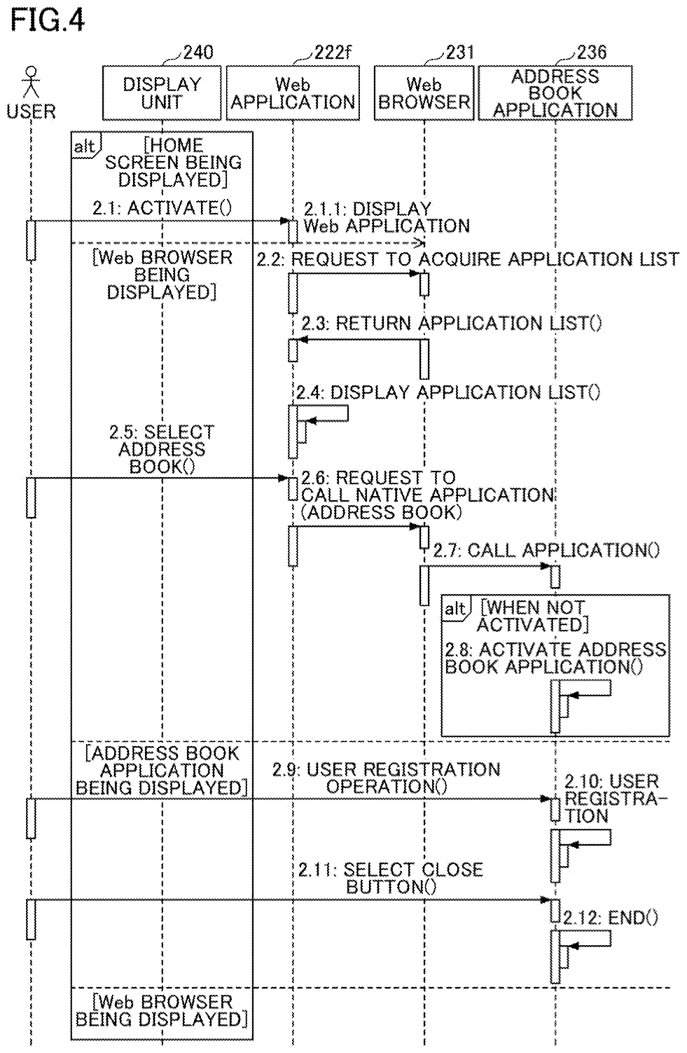

FIG. 4 is a sequence diagram illustrating another example of a process sequence by the MFP 100 according to an embodiment of the present invention. Here, an example in which the web application 222f acquires a list of native applications and calls the address book application 236 selected by a user in the list of native applications, will be described.

First, when the user selects an icon 532 for activating the web application 222f in the home screen 500 (see FIG. 5) displayed on the display unit 240, the web browser 231 is activated, and the web browser 231 activates the web application 222f from the URL associated with the icon 532 (2.1). When the web application 222f is activated, the web browser 231 displays the display screen of the web application 222f on the display unit 240 (2.1.1).

Next, the web application 222f requests the web browser 231 to acquire a list of native applications (2.2). Specifically, the web application 222f activates the list acquiring unit 231B included in the web browser 231. For example, the list acquiring unit 231B is implemented by an API that acquires a list of native applications using JavaScript. The API that acquires the list of native applications acquires the application name and package name of each of a plurality of native applications as the list of native applications.

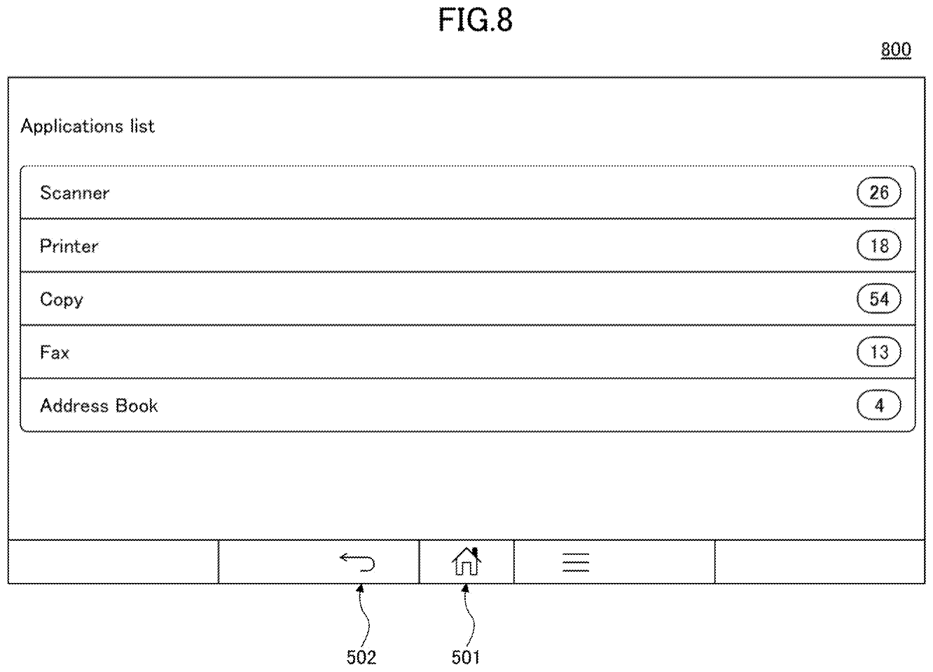

The list of the native applications acquired by the list acquiring unit 231B is returned to the web application 222f (2.3). The web application 222f causes a display screen 800 of the list of native applications (see FIG. 8) to be displayed on the display unit 240 (2.4).

Next, in the display screen 800 of the list of native applications displayed by the display unit 240, the user selects a selection item corresponding to the address book application 236 (2.5).

According to the selection of the selection item corresponding to the address book application 236, the web application 222f requests the web browser 231 to call the address book application 236 (2.6). Specifically, the web application 222f activates the calling unit 231A included in the web browser 231. For example, the calling unit 231A is implemented by an API using JavaScript. For example, the calling unit 231A includes an API for calling a native application and an API for acquiring the calling result of calling the native application. The API that calls the native application is executed by using the package name of the native application to be called (in this example, the address book application 236) as a parameter. The API, that acquires the calling result of calling the native application, returns “successful” or “unsuccessful” as a parameter of the calling result of calling the native application.

The web browser 231 (the calling unit 231A) calls the address book application 236 in response to a request from the web application 222f (2.7). Specifically, the web browser 231 (the calling unit 231A) calls the address book application 236 by activating the calling unit 212 provided from the OS 210. For example, when the OS 210 is Android, the calling unit 212 is implemented by the startActivity method provided by the OS 210. The calling unit 212 is executed by setting the package name of the native application to be called (in this example, the address book application 236), the activity name, and the parameter to be transferred to the native application to be called.

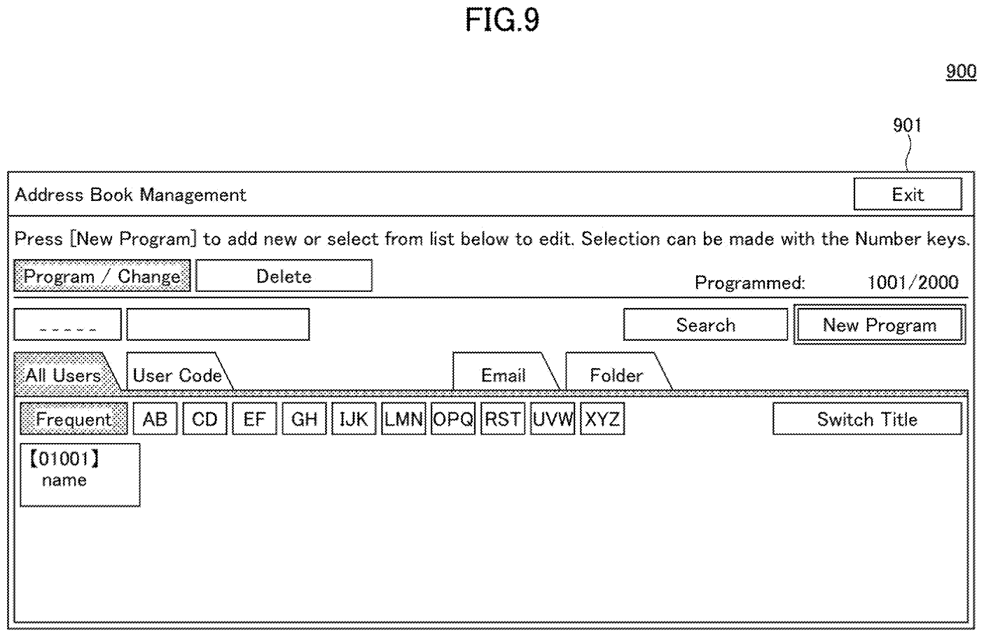

When the address book application 236 has not been activated in response to a call from the web browser 231 (the calling unit 231A), the address book application 236 is activated (2.8), and the display unit 240 displays a display screen 900 (see FIG. 9) of the address book application 236 on the frontmost side of the display. That is, the display unit 240 displays the display screen 900 by superimposing the display screen 900 of the address book application 236 on the display screen of the web application 222f.

When the user performs a user registration operation (2.9) in the display screen 900 of the address book application 236 displayed in the display unit 240, the address book application 236 performs the user registration process with respect to the address book (2.10).

When the user selects an exit button 901 (see FIG. 9) in the display screen 900 of the address book application 236 displayed on the display unit 240 (2.11), the address book application 236 is terminated (2.12). Accordingly, the display unit 240 ends the display of the display screen 900 of the address book application 236. As a result, the display unit 240 displays the display screen of the web application 222f on the frontmost side of the display.

### <Example of the Home Screen 500>

FIG. 5 is a diagram illustrating an example of the home screen 500 displayed on the MFP 100 according to an embodiment of the present invention.

As illustrated in FIG. 5, the home screen 500 includes icons 511 to 515 for directly activating a native application (i.e., without involving the web application 222). The icon 511 is for directly activating the copy application 234. The icon 512 is for directly activating the scan application 232. The icon 513 is for directly activating the printer application 233. The icon 514 is for directly activating the address book application 236. The icon 515 is for directly activating the web browser 231.

The home screen 500 includes icons 531 and 532 for activating a native application via the web application 222. The icons 531 and 532 activate the web browser 231, and activate the web application 222 from the web browser 231. For example, the icon 531 is for activating the web application 222a (i.e., the web application 222 that calls the scan application 232). For example, the icon 532 is for activating the web application 222f (that is, the web application 222 for acquiring the list of native applications).

The home screen 500 includes a home button 501 and the return button 502. The home button 501 is a button for displaying the home screen 500 on the display unit 240 when another display screen is displayed on the display unit 240. The return button 502 is a button for displaying the previous display screen on the display unit 240.

<Example of the Display Screen 600 of the Web Application 222a>

FIG. 6 is a diagram illustrating an example of the display screen 600 of the web application 222a displayed in the MFP 100 according to an embodiment of the present invention.

The display screen 600 illustrated in FIG. 6 is a display screen of the web application 222a displayed on the display unit 240 by the web browser 231 when the web application 222a for calling the scan application 232 is activated in the MFP 100. As illustrated in FIG. 6, with the display screen 600, it is possible to make minimum settings for the scan application 232. For example, in the example illustrated in FIG. 6, with the display screen 600, it is possible to set the mail address to which the scan data is to be transmitted.

The display screen 600 is provided with a scanner button 601. When the scanner button 601 is selected by the user, the web browser 231 (the calling unit 231A) calls the scan application 232. At this time, the settings made in the display screen 600 are carried on into the scan application 232. That is, the user can call the scan application 232 via the web application 222a.

The home button 501 and the return button 502 are provided in the display screen 600 similar to the home screen 500 illustrated in FIG. 5. When the home button 501 is selected by the user in the display screen 600, the home screen 500 is displayed on the display unit 240. When the return button 502 in the display screen 600 is selected by the user, the display unit 240 displays a display screen that is the one displayed immediately before the display screen 600.

### <Example of the Display Screen 700 of the Scan Application 232>

FIG. 7 illustrates an example of the display screen 700 of the scan application 232 displayed on the MFP 100 according to an embodiment of the present invention.

The display screen 700 illustrated in FIG. 7 is the display screen of the scan application 232 displayed on the display unit 240 by the web browser 231 when the scan application 232 is called from the web application 222a in the MFP 100.

In the display screen 700, detailed settings of the scan application 232 can be made, and an instruction for executing a scanning process by the scanner unit 131 can be given, etc. In the example illustrated in FIG. 7, a set value (the mail address of the transmission destination of the scan data) carried over from the display screen 600 of the web application 222a (see FIG. 6) is automatically set in the display screen 700.

Further, the start button 701 is provided in the display screen 700. When the start button 701 is selected by the user, a scanning process by the scanner unit 131 is executed based on the setting made in the display screen 700.

The home button 501 and the return button 502 are provided in the display screen 700 similar to the home screen 500 illustrated in FIG. 5. When the home button 501 is selected by the user in the display screen 700, the home screen 500 is displayed on the display unit 240. When the return button 502 is selected by the user in the display screen 700, the display unit 240 displays a display screen (for example, the display screen 600 illustrated in FIG. 6) that is the one displayed immediately before the display screen 700.

### <Example of the Display Screen 800 of Native Application List>

FIG. 8 is a diagram illustrating an example of the display screen 800 of a list of native applications displayed in the MFP 100 according to an embodiment of the present invention.

The display screen 800 illustrated in FIG. 8 is a display screen displayed by the web browser 231 when the list acquiring unit 231B acquires a list of native applications in response to a request from the web application 222f. As illustrated in FIG. 8, the display screen 800 displays a list of titles of each of the plurality of native applications acquired by the list acquiring unit 231B.

For example, in the example illustrated in FIG. 8, a list of the titles (scanner, printer, copy, fax, and address book) of a plurality of native applications (the scan application 232, the printer application 233, the copy application 234, the fax application 235, and the address book application 236) included in the MFP 100, is displayed. The number displayed at the right end of each title indicates the number of times that the corresponding native application having the title has been executed.

The user can select any native application as the native application to be called, in the display screen 800. For example, when the address book application 236 (“address book”) is selected by the user in the display screen 800, the web application 222f requests the web browser 231 to call the address book application 236. The web browser 231 (the calling unit 231A) calls the address book application 236 in response to a request from the web application 222f. That is, the user can call the address book application 236 via the web application 222f.

### <Example of the Display Screen 900 of the Address Book Application 236>

FIG. 9 is a diagram illustrating an example of the display screen 900 of the address book application 236 displayed in the MFP 100 according to an embodiment of the present invention.

The display screen 900 illustrated in FIG. 9 is the display screen of the address book application 236 displayed on the display unit 240 by the web browser 231 when the address book application 236 is called from the web application 222f in the MFP 100.

In the display screen 900, various functions related to the address book application 236 (e.g., adding, changing, deleting a user) can be used.

The exit button 901 is provided in the display screen 900. When the exit button 901 is selected by the user, the address book application 236 is terminated. Accordingly, the display unit 240 ends the display of the display screen 900.

As described above, the MFP 100 according to an embodiment of the present invention includes a native application that operates on the MFP 100 and that executes a predetermined function included in the MFP 100, the web browser 231, the web application 222 usable from the web browser 231, and the calling unit 231A that calls a native application in response to a request from the web application 222.

Thus, for example, the MFP 100 according to an embodiment of the present invention executes some of the processes by a native application, and, therefore, the processing speed can be improved compared to the case where all of the processes are executed by the web application.

For example, the MFP 100 according to an embodiment of the present invention executes some of the processes by a native application, and, therefore, it is possible to prevent the source codes relevant to some of the processes from being easily viewed.

For example, the MFP 100 according to an embodiment of the present invention executes some of the processes by a native application, and, therefore, an existing native application can be used, so that the number of man-hours for developing a web application can be reduced.

For example, the MFP 100 according to an embodiment of the present invention can call a native application from a web application, and, therefore, the web application and the native application can be easily activated from icons and the like.

The MFP 100 according to an embodiment of the present invention further includes the list acquiring unit 231B for acquiring a list of native applications in response to a request from the web application 222, and the web application 222 displays a list of the native applications acquired by the list acquiring unit 231B on the web browser 231.

Accordingly, the MFP 100 according to an embodiment of the present invention allows the user to select a plurality of native applications that can be called from the web application 222, on the web browser 231.

Further, in the MFP 100 according to an embodiment of the present invention, when one native application is selected from the list of native applications displayed by the web browser 231, the calling unit 231A calls the selected one native application in response to a request from the web application 222.

Accordingly, the MFP 100 according to an embodiment of the present invention can easily activate one native application from the web application 222, simply by having the user select one native application from the list of native applications.

Further, in the MFP 100 according to an embodiment of the present invention, the calling unit 231A returns the calling result of calling the native application, to the web application 222.

Accordingly, the MFP 100 according to an embodiment of the present invention can perform a process according to the calling result of calling the native application, in the web application 222.

In the MFP 100 according to an embodiment of the present invention, the list acquiring unit 231B may acquire the shortcut information of each native application together with the list of native applications.

Accordingly, the MFP 100 according to an embodiment of the present invention can use the shortcut information acquired by the list acquiring unit 231B for activating each native application from the web application 222.

In the MFP 100 according to an embodiment of the present invention, the list acquiring unit 231B may acquire an icon of each native application together with the list of the native applications.

Accordingly, the MFP 100 according to an embodiment of the present invention can use the icon acquired by the list acquiring unit 231B for activating each native application from the web application 222.

According to one embodiment of the present invention, a native application can be used from a web application.

The information processing apparatus, the method, and the recording medium are not limited to the specific embodiments described in the detailed description, and variations and modifications may be made without departing from the spirit and scope of the present invention.

The “information processing apparatus” is not limited to a MFP if the apparatus is equipped with a native application. The “information processing apparatus” may be, for example, a projector (PJ), an Interactive White Board (IWB; a whiteboard having an electronic blackboard function capable of mutual communication), an output device such as a digital signage, a Head Up Display (HUD) device, an industrial machine, an imaging device, a sound collector, a medical device, a network home appliance, an automobile (connected car), a notebook personal computer (PC), a mobile phone, a smartphone, a tablet terminal, a game machine, a Personal Digital Assistant (PDA), a digital camera, a wearable PC, or a desktop PC.

What is claimed is:

1. An information processing apparatus comprising:
processing circuitry; and
a memory storing computer-executable instructions that cause the processing circuitry to:
call a native application operating on an operating system, in response to a request from a web application that can be used from a web browser.

2. The information processing apparatus according to claim 1, wherein the processing circuitry is further caused to:
acquire a list of the native applications in response to the request from the web application; and
display, on the web browser by the web application, the acquired list of the native applications.

3. The information processing apparatus according to claim 2, wherein the processing circuitry is further caused to:
call one native application selected from the list of the native applications displayed in the web browser in response to the request from the web application, upon determining that the one native application has been selected from the list of the native applications displayed in the web browser.

4. The information processing apparatus according to claim 2, wherein the processing circuitry is further caused to:
acquire shortcut information of each of the native applications together with the list of the native applications.

5. The information processing apparatus according to claim 2, wherein the processing circuitry is further caused to:
acquire an icon of each of the native applications together with the list of the native applications.

6. The information processing apparatus according to claim 1, wherein the processing circuitry is further caused to:
return a calling result of calling the native application to the web application.

7. A method for controlling an information processing apparatus, the method comprising:
calling a native application operating on an operating system, in response to a request from a web application that can be used from a web browser.

8. A non-transitory computer-readable recording medium storing a program that causes a computer to execute a process performed in an information processing apparatus, the process comprising:
calling a native application operating on an operating system, in response to a request from a web application that can be used from a web browser.
